(19) United States
(12) Patent Application Publication
(10) Pub. No.: US 2024/0191771 A1
(43) Pub. Date: Jun. 13, 2024

(54) HYDRAULIC SYSTEM FOR VEHICLE

(71) Applicant: Hitachi Astemo, Ltd., Hitachinaka-shi (JP)

(72) Inventors: Yosuke MURAKAMI, Hitachinaka-shi (JP); Daiki ATSUTA, Hitachinaka-shi (JP); Tomoharu TSUCHIYA, Hitachinaka-shi (JP)

(73) Assignee: Hitachi Astemo, Ltd., Hitachinaka-shi (JP)

(21) Appl. No.: 18/583,302

(22) Filed: Feb. 21, 2024

Related U.S. Application Data
(63) Continuation of application No. PCT/JP2022/020156, filed on May 13, 2022.

(30) Foreign Application Priority Data
Nov. 11, 2021 (JP) 2021-184302

(51) Int. Cl. F16F 9/56; B60T 8/1761; F16F 9/46

(52) U.S. Cl. CPC F16F 9/56; B60T 8/1761; F16F 9/465

(57) ABSTRACT

A vehicular hydraulic system includes a first hydraulic drive device configured to be driven by a hydraulic pressure generated in a first hydraulic pump, a second hydraulic drive device configured to exhibit an action different from that of the first hydraulic drive device and to be driven by a hydraulic pressure generated in a second hydraulic pump, and a single motor serving as a common power source for the first hydraulic pump and the second hydraulic pump.

### CROSS-REFERENCE TO RELATED APPLICATIONS

This is a Continuation of International Application No. PCT/JP2022/020156 filed on May 13, 2022, which claims the benefit of priority to Japanese Patent Application No. 2021-184302 filed on Nov. 11, 2021, the entire contents of all of which are incorporated herein by reference.

### FIELD OF THE INVENTION

The present disclosure relates to a vehicular hydraulic system that is suitable for being mounted in various vehicles such as a saddle-riding type vehicle.

### BACKGROUND OF THE INVENTION

Various vehicles such as a saddle-riding type vehicle typified by a motorcycle, a three-wheeled vehicle, and the like include a vehicle type in which a vehicular hydraulic system including a plurality of hydraulic drive devices is mounted. The plurality of hydraulic drive devices are driven by hydraulic pressures generated in hydraulic pumps, respectively. The hydraulic pumps are driven by motors, respectively. This vehicular hydraulic system including the plurality of hydraulic drive devices is disclosed in, for example, in JP6021561B.

The vehicular hydraulic system disclosed in JP6021561B includes both an antilock brake system (ABS) that controls a hydraulic pressure to be applied to a hydraulic brake of a motorcycle, and a vehicle height adjustment mechanism that adjusts a vehicle height of the motorcycle. The ABS and the vehicle height adjustment mechanism are two types of hydraulic drive devices that exhibit different actions.

The vehicular hydraulic system disclosed in JP6021561B includes an accessory in which the hydraulic pumps, the motors, and the like are mutually overlapped by the ABS and the vehicle height adjustment mechanism that exhibit different actions. The same applies to other vehicular hydraulic systems to be mounted in a vehicle. In recent years, the number of accessories mounted in a vehicle tends to increase. Therefore, it is required to sufficiently consider various design factors such as a space for arranging overlapped accessories in the vehicle and weight distribution.

### SUMMARY OF THE INVENTION

An object of the present disclosure is to provide a vehicular hydraulic system that enables to reduce an arrangement space and mounting weight with respect to a vehicle.

For example, as disclosed in JP6021561B, the present inventors have gained a new insight that in a vehicular hydraulic system provided with two hydraulic drive devices exhibiting different actions, a single motor can serve as a common power source by continuously rotating the single motor. As a result, it has been found that a vehicular hydraulic system, which enables to reduce an arrangement space and mounting weight with respect to a vehicle, can be provided. The present invention was completed based on these findings.

According to the present disclosure, there is provided a vehicular hydraulic system that includes: a first hydraulic drive device configured to be driven by a hydraulic pressure generated in a first hydraulic pump; a second hydraulic drive device configured to exhibit an action different from that of the first hydraulic drive device, and to be driven by a hydraulic pressure generated in a second hydraulic pump; and a single motor serving as a common power source for the first hydraulic pump and the second hydraulic pump.

According to the present disclosure, a vehicular hydraulic system, which enables to reduce an arrangement space and mounting weight with respect to a vehicle, can be provided.

### BRIEF DESCRIPTION OF THE DRAWINGS

Exemplary embodiment(s) of the present invention will be described in detail based on the following figures, wherein:

FIG. 1 is a side view of a motorcycle in which a vehicular hydraulic system according to Example 1 is mounted;

FIG. 2 is a diagram illustrating a hydraulic shock absorber and a hydraulic jack shown in FIG. 1;

FIG. 3 is a diagram illustrating a hydraulic circuit of the vehicular hydraulic system shown in FIG. 1;

FIG. 4 is a control flowchart of a control device shown in FIG. 3; and

FIG. 5 is a diagram illustrating a hydraulic circuit of a vehicular hydraulic system according to Example 2.

### DETAILED DESCRIPTION OF THE INVENTION

Embodiments of the present disclosure will be described below with reference to the accompanying drawings. The embodiments illustrated in the accompanying drawings are examples of the present disclosure, and the present invention is not limited to the embodiments.

### Example 1

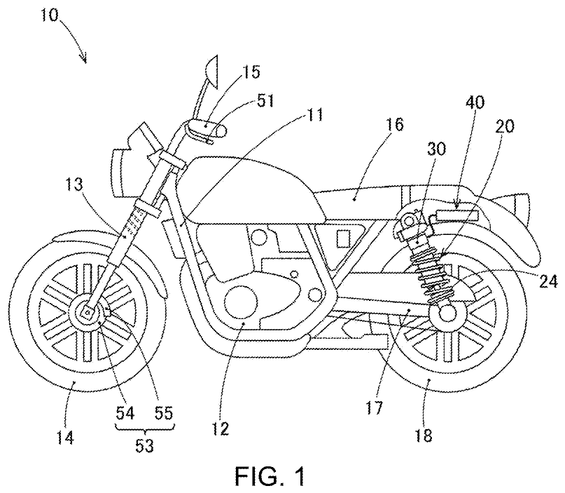

Referring to FIGS. 1 to 4, a vehicular hydraulic system 40 according to Example 1 and a motorcycle 10 (a saddle-riding type vehicle 10) having the vehicular hydraulic system 40 will be described.

As illustrated in FIG. 1, the vehicular hydraulic system 40 is mounted in various vehicles such as a saddle-riding type vehicle. For example, the vehicular hydraulic system 40 is mounted in the motorcycle 10 that is a saddle-riding type vehicle on which an occupant rides.

The motorcycle 10 includes a vehicle body 11, an engine 12 supported at a lower central portion of the vehicle body 11, left and right front forks 13 provided at a front portion of the vehicle body 11 (only one of the front forks is shown), a front wheel 14 supported by these front forks 13, a steering handle 15 connected to the front forks 13, and an occupant seat 16 provided at an upper central portion of the vehicle body 11. The motorcycle 10 further includes a wheel support mechanism 17 typified by a link mechanism, a swing arm, or the like, which is capable of extending rearward from a rear portion of the vehicle body 11 and of swinging in an up-down direction, a rear wheel 18 supported by the wheel support mechanism 17, and a hydraulic shock absorber 20 stretched between the vehicle body 11 and the wheel support mechanism 17. The hydraulic shock absorber 20 is used as a rear cushion.

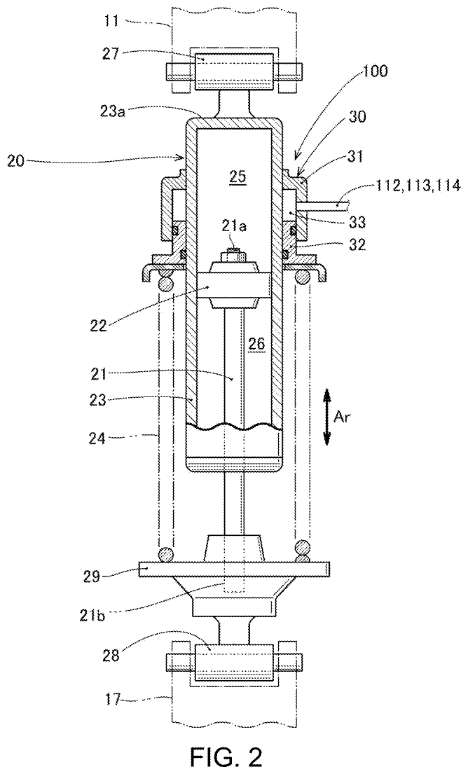

As illustrated in FIG. 2, the hydraulic shock absorber 20 includes a piston rod 21, a piston 22 provided at one end portion 21a of the piston rod 21, a damper tube 23 accommodating the piston 22 in a reciprocally movable manner, and a suspension spring 24 biasing the damper tube 23 and the piston rod 21 in opposite directions. The inside of the damper tube 23 is divided into two oil chambers 25, 26 by the piston 22.

A first support portion 27 is provided at one end portion 23a of the closed damper tube 23. The first support portion 27 is supported by the vehicle body 11 (see FIG. 1) in a swingable manner. A second support portion 28 is provided at the other end portion 21b of the piston rod 21. The second support portion 28 is supported by the wheel support mechanism 17 (see FIG. 1) in a swingable manner.

The hydraulic shock absorber 20 is assembled with a jack portion 30 for adjusting the suspension spring 24 in an expansion and contraction direction Ar. The jack portion 30 includes a jack housing 31 and a plunger 32. The jack housing 31 and the plunger 32 are positioned on a side of the suspension spring 24 opposite to a retainer 29. Ends of the suspension spring 24 made of a compression coil spring are supported by the retainer 29 provided at the other end portion 21b of the piston rod 21 and the plunger 32 of the jack portion 30.

The jack housing 31 is a tubular member that surrounds an outer peripheral surface of the damper tube 23, and only a side thereof where the suspension spring 24 is arranged is opened. The outer peripheral surface of the damper tube 23 and the jack housing 31 are sealed. An inside portion 33 of the jack housing 31 is referred to as a “jack chamber 33”.

The plunger 32 is an annular member fitted to the outer peripheral surface of the damper tube 23 in a manner of being movable forward and backward, and is held in the jack chamber 33 in a manner of being movable forward and backward. The plunger 32 pushes the suspension spring 24. The plunger 32 and the jack chamber 33 are sealed. The jack chamber 33 is filled with oil that can push out the plunger 32 in an advancing direction. The plunger 32 advances and retreats by adjusting a hydraulic pressure of the oil in the jack chamber 33. As a result, the suspension spring 24 can be adjusted in the expansion and contraction direction Ar by the plunger 32.

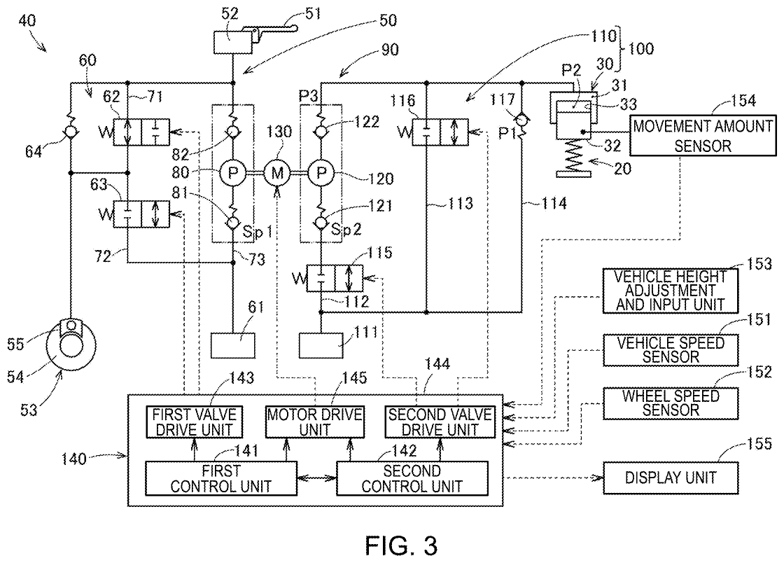

Next, the vehicular hydraulic system 40 will be described in detail with reference to FIG. 3.

The vehicular hydraulic system 40 includes a first hydraulic circuit 50 including a first hydraulic drive device 60 and a first hydraulic pump 80, a second hydraulic circuit 90 including a second hydraulic drive device 100 and a second hydraulic pump 120, and a single motor 130 (an electric motor 130) serving as a common power source for the first hydraulic pump 80 and the second hydraulic pump 120. The first hydraulic circuit 50 and the second hydraulic circuit 90 are separated and independent from each other. The first hydraulic drive device 60 is driven by a hydraulic pressure generated in the first hydraulic pump 80. The second hydraulic drive device 100 is driven by a hydraulic pressure generated in the second hydraulic pump 120.

The second hydraulic drive device 100 is a hydraulic drive device that exhibits an action different from that of the first hydraulic drive device 60. That is, the first hydraulic drive device 60 and the second hydraulic drive device 100 have different operation modes (different drive forms, and different types). As an example, the first hydraulic drive device 60 is implemented by a hydraulic brake which is allowed to be provided in the motorcycle 10 (see FIG. 1). Further, the second hydraulic drive device 100 is implemented by a hydraulic jack for adjusting a vehicle height of the motorcycle 10.

The first hydraulic drive device 60 implemented by the hydraulic brake applies a braking force to at least one wheel (for example, the front wheel 14) of the front wheel 14 and the rear wheel 18 illustrated in FIG. 1 (has a first operation mode). The second hydraulic drive device 100 implemented by the hydraulic jack adjusts the vehicle height of the motorcycle 10 (has a second operation mode). Therefore, the first hydraulic drive device 60 and the second hydraulic drive device 100 have different operation modes. Hereinafter, the first hydraulic drive device 60 may be referred to as a “hydraulic brake 60”, and the second hydraulic drive device 100 may be referred to as a “hydraulic jack 100” as appropriate.

As described above, the first hydraulic drive device 60 included in the first hydraulic circuit 50 and the second hydraulic drive device 100 included in the second hydraulic circuit 90 have different operation modes. However, the first hydraulic circuit 50 and the second hydraulic circuit 90 are separated and independent from each other. Therefore, the first hydraulic circuit 50 and the second hydraulic circuit 90 can operate more appropriately without mutual interference of hydraulic operations.

First, the first hydraulic circuit 50 will be described.

The first hydraulic circuit 50 is, for example, a brake circuit that brakes the front wheel 14 (see FIG. 1), and includes a brake operation member 51 such as a brake lever provided in the steering handle 15, a master cylinder 52 that generates a hydraulic pressure of the oil (a fluid pressure of a hydraulic fluid) in accordance with an operation of the brake operation member 51, and a wheel brake 53 that applies a brake pressure to the front wheel 14 by using the hydraulic pressure generated in the master cylinder 52. The wheel brake 53 includes a brake disc 54 provided in the front wheel 14 and a brake caliper 55 for applying a brake pressure to the brake disc 54. When the hydraulic pressure (a brake hydraulic pressure) generated in the master cylinder 52 in accordance with the operation of the brake operation member 51 is applied to the brake caliper 55, the brake pressure can be applied to the brake disc 54.

Further, the first hydraulic circuit 50 includes the first hydraulic drive device 60 which is capable of adjusting the brake pressure of the wheel brake 53, that is, an antilock brake system 60 (an ABS 60). The ABS 60 controls the brake pressure applied by the brake caliper 55 such that a slip ratio becomes a desired slip ratio in order to avoid slipping (a locked state) of the front wheel 14 during braking of the front wheel 14. As a result, the ABS 60 can perform adjustment to reduce the brake pressure, and can perform adjustment to maintain the brake pressure (to prevent excessive increase of the brake pressure). The ABS 60 can also perform adjustment to increase the brake pressure.

The first hydraulic drive device 60 is controlled by a first control unit 141 to be described later. The first hydraulic drive device 60 includes a reservoir 61 (a first reservoir 61) for temporarily storing the oil, an inlet control valve 62 (a first inlet control valve 62) provided between the master cylinder 52 and the brake caliper 55, an outlet control valve 63 (a first outlet control valve 63) provided between the brake caliper 55 and the first reservoir 61, and a check valve 64 connected in parallel to the first inlet control valve 62. The first reservoir 61 is implemented by, for example, a sealed container.

The first inlet control valve 62 is implemented by a normally-opened electromagnetic valve that is opened at a normal time during which no control signal is received from the first control unit 141, and the first inlet control valve 62 is interposed in a first brake hydraulic passage 71 from the master cylinder 52 to the brake caliper 55. In the normal time, the first inlet control valve 62 allows the brake hydraulic pressure to be applied from the master cylinder 52 to the brake caliper 55. When the front wheel 14 is likely to be locked, the first inlet control valve 62 receives the control signal of the first control unit 141, changes from an opened state to a closed state, and blocks the brake hydraulic pressure applied to the brake caliper 55.

The first outlet control valve 63 is implemented by a normally-closed electromagnetic valve that is closed at a normal time during which no control signal is received from the first control unit 141, and is interposed in a second brake hydraulic passage 72 from the brake caliper 55 to the first reservoir 61. When the front wheel 14 is likely to be locked, the first outlet control valve 63 receives the control signal of the first control unit 141, changes from a closed state to an opened state, and releases the brake hydraulic pressure applied to the brake caliper 55 to the first reservoir 61.

The check valve 64 is connected in parallel to the first inlet control valve 62 with respect to the first brake hydraulic passage 71, and allows the brake hydraulic pressure to flow only in a direction from the brake caliper 55 to the master cylinder 52. Therefore, even in a case where the first inlet control valve 62 is in the closed state, when an operating force of the brake operation member 51 is released, the flow of the oil from the brake caliper 55 to the master cylinder 52 can be allowed.

The first hydraulic pump 80 included in the first hydraulic circuit 50 is interposed in a third brake hydraulic passage 73 from the first reservoir 61 to the master cylinder 52. The first hydraulic pump 80 is capable of sucking the oil temporarily stored in the first reservoir 61 and discharging the oil toward a master cylinder 52 side so as to discharge the oil to the brake caliper 55 through the third brake hydraulic passage 73 and the first brake hydraulic passage 71.

The first hydraulic pump 80 includes an intake valve 81 (a first intake valve 81) at a sucking port and a discharge valve 82 (a first discharge valve 82) at a discharge port. The first intake valve 81 has a configuration of a check valve that allows only an inflow of the oil from a first reservoir 61 side to the first hydraulic pump 80. The first discharge valve 82 has a configuration of a check valve that allows only the flow of the oil from the first hydraulic pump 80 to the master cylinder 52 side. In addition, the first intake valve 81 and the first discharge valve 82 may be integrated into the first hydraulic pump 80, or may be separated from each other in the first hydraulic pump 80.

Next, the second hydraulic circuit 90 will be described.

The second hydraulic circuit 90 is a jack circuit for adjusting the vehicle height of the motorcycle 10, and includes the second hydraulic drive device 100 as described above. The second hydraulic drive device 100 has a configuration of the hydraulic jack for adjusting the vehicle height of the motorcycle 10. The second hydraulic drive device 100 can adjust a height of the occupant seat 16 with respect to a center of the rear wheel 18. The second hydraulic drive device 100 (the hydraulic jack 100) includes the jack portion 30 assembled to the hydraulic shock absorber 20 described above and a hydraulic pressure control unit 110 that controls a hydraulic pressure of the jack portion 30.

The hydraulic pressure control unit 110 is controlled by a second control unit 142 to be described later. The hydraulic pressure control unit 110 includes a reservoir 111 (a second reservoir 111) in which the oil is stored, and three jack hydraulic passages 112 to 114 that are connected in parallel between the second reservoir 111 and the jack chamber 33.

The second reservoir 111 is implemented by, for example, an open type container that is open to the atmosphere. The first jack hydraulic passage 112 has a configuration of an oil supply passage through which the oil is supplied from the second reservoir 111 to the jack chamber 33, and the second hydraulic pump 120 is interposed therein. The second jack hydraulic passage 113 has a configuration of an oil return passage through which the oil is returned from the jack chamber 33 to the second reservoir 111. The third jack hydraulic passage 114 has a configuration of an oil pressure relief passage through which an excessive hydraulic pressure is released to the second reservoir 111.

The hydraulic pressure control unit 110 further includes an inlet control valve 115 (a second inlet control valve 115) provided in the first jack hydraulic passage 112, an outlet control valve 116 (a second outlet control valve 116) provided in the second jack hydraulic passage 113, and a pressure valve 117 provided in the third jack hydraulic passage 114.

The second inlet control valve 115 is implemented by a normally-closed electromagnetic valve that is closed at a normal time during which no control signal is received from the second control unit 142, and the second inlet control valve 115 is interposed between the second reservoir 111 and the sucking port of the second hydraulic pump 120 in the first jack hydraulic passage 112. When the vehicle height of the motorcycle 10 is increased, the second inlet control valve 115 receives a control signal of the second control unit 142, changes from the closed state to the opened state, and allows a jack hydraulic pressure to be applied from the second reservoir 111 to the jack chamber 33.

The second outlet control valve 116 is implemented by a normally-closed electromagnetic valve that is closed at a normal time during which no control signal is received from the second control unit 142, and is interposed in the second jack hydraulic passage 113. When the vehicle height of the motorcycle 10 is reduced, the second outlet control valve 116 receives a control signal of the second control unit 142, changes from the closed state to the opened state, and returns the jack hydraulic pressure of the jack chamber 33 to the second reservoir 111.

The pressure valve 117 releases the excessive hydraulic pressure generated in the jack chamber 33 and the third jack hydraulic passage 114. The pressure valve 117 releases the excessive hydraulic pressure applied to the discharge side of the second hydraulic pump 120 to the second reservoir 111 so as to protect the second hydraulic pump 120.

The second hydraulic pump 120 can suck the oil stored in the second reservoir 111 and discharge the oil to the jack chamber 33. The second hydraulic pump 120 includes an intake valve 121 (a second intake valve 121) at the sucking port. The second hydraulic pump 120 also includes a discharge valve 122 (a second discharge valve 122) at a discharge port. The second intake valve 121 has a configuration of a check valve that allows only an inflow of the oil from the second reservoir 111 to the second hydraulic pump 120. The second discharge valve 122 has a configuration of a check valve that allows only the flow of the oil from the second hydraulic pump 120 to a jack chamber 33 side. In addition, the second intake valve 121 and the second discharge valve 122 may be integrated into the second hydraulic pump 120, or may be separated from each other in the second hydraulic pump 120.

Each of the first hydraulic pump 80 and the second hydraulic pump 120 is implemented by, for example, a plunger pump. A negative pressure for suction intermittently occurs at the sucking port of each of the pumps 80, 120 implemented by plunger pumps. However, the operation modes of the hydraulic brake 60 and the hydraulic jack 100 are different from each other. Therefore, the hydraulic jack 100 may be stopped during the operation of the hydraulic brake 60.

In contrast, since the motor 130 is a common power source for the first hydraulic pump 80 and the second hydraulic pump 120, the motor 130 continuously rotates in one direction so that both the pumps 80, 120 can be simultaneously driven. When only the pump 120 (the second hydraulic pump 120) of these pumps 80, 120 is driving a load, the pump 80 (the first hydraulic pump 80) is in a so-called idling state without a load. As a result, the negative pressure for suction (a pump suction negative pressure), which occurs at the sucking port of the pump 80 in the idling state, occurs.

The first reservoir 61 of the hydraulic brake 60 is a sealed container. When the pump suction negative pressure of the first hydraulic pump 80 increases, a first reference negative pressure Sp1 of the first intake valve 81 is set to be large such that the pump suction negative pressure does not affect the brake hydraulic pressure of the first hydraulic circuit 50. Therefore, a stable braking action achieved by the first hydraulic circuit 50 can be sufficiently maintained.

On the other hand, the second reservoir 111 of the hydraulic jack 100 is an open type container that is open to the atmosphere. A second reference negative pressure Sp2 of the second intake valve 121 is set to be small such that the oil can be easily sucked from the open type second reservoir 111 by the pump suction negative pressure of the second hydraulic pump 120. Therefore, a stable jacking action achieved by the second hydraulic circuit 90 can be sufficiently maintained.

A relation between the first reference negative pressure Sp1 and the second reference negative pressure Sp2 is summarized as follows.

The hydraulic brake 60 includes the first reservoir 61, in which the oil is stored, connected to the brake caliper 55. The first intake valve 81, which allows only the inflow of the oil from the first reservoir 61 to the first hydraulic pump 80, is interposed in an oil passage 73 (the third brake hydraulic passage 73) through which the oil is sucked from the first reservoir 61 by the first hydraulic pump 80.

The hydraulic jack 100 includes the second reservoir 111 in which the oil is stored. The second intake valve 121, which allows only the inflow of the oil from the second reservoir 111 to the second hydraulic pump 120, is interposed in an oil passage 112 (the first jack hydraulic passage 112) through which the oil flows from the second reservoir 111 to the sucking port of the second hydraulic pump 120.

The reference negative pressure Sp1 (the first reference negative pressure Sp1) with which the first intake valve 81 is opened due to the sucking of the first hydraulic pump 80 is set to be larger than the reference negative pressure Sp2 (the second reference negative pressure Sp2) with which the second intake valve 121 is opened due to the sucking of the second hydraulic pump 120. Therefore, both the stable braking action achieved by the first hydraulic circuit 50 and the stable jacking action achieved by the second hydraulic circuit 90 can be sufficiently maintained.

Here, a setting value of a reference pressure P1 (a valve opening pressure P1) with which the pressure valve 117 described above is opened will be described. The second hydraulic circuit 90 includes the pressure valve 117 that protects the second hydraulic pump 120. A hydraulic pressure P2 of the jack chamber 33 necessary for increasing the vehicle height of the motorcycle 10 to a maximum value by the hydraulic jack 100 is referred to as a “maximum hydraulic pressure P2”. The maximum hydraulic pressure P2 corresponds to a maximum jack pressure P2 used for driving the hydraulic jack 100. A maximum value of a discharge pressure generated in the second hydraulic pump 120 is referred to as a “maximum discharge pressure P3”.

The valve opening pressure P1 of the pressure valve 117 is set to be larger than the maximum jack pressure P2 used for driving the hydraulic jack 100 and smaller than the maximum discharge pressure P3 of the second hydraulic pump 120 (P2<P1<P3). Therefore, when the jack hydraulic pressure of the third jack hydraulic passage 114 or the jack chamber 33 exceeds the maximum jack pressure P2 and becomes an excessive pressure, the excessive jack hydraulic pressure can be released to the second reservoir 111. As a result, since no excessive load is applied to the second hydraulic pump 120, the second hydraulic pump 120 can be protected. More specifically, the maximum discharge pressure P3 of the second hydraulic pump 120 is an outlet pressure of the second discharge valve 122.

Next, a control system of the vehicular hydraulic system 40 will be described.

As illustrated in FIG. 3, the vehicular hydraulic system 40 includes a control device 140 that controls the first hydraulic drive device 60, the second hydraulic drive device 100, and the motor 130. The control device 140 receives signals from, for example, various input members such as a vehicle speed sensor 151, a wheel speed sensor 152, a vehicle height adjustment and input unit 153, and a movement amount sensor 154, executes various preset controls, and displays control states on a display unit 155.

The vehicle speed sensor 151 is capable of detecting a traveling speed of the motorcycle 10. The wheel speed sensor 152 is capable of detecting a rotational speed of the front wheel 14 or the rear wheel 18.

The vehicle height adjustment and input unit 153 inputs an adjustment amount of the vehicle height of the motorcycle 10, and is implemented by, for example, a user interface operable by a driver, such as a touch panel. As an example of the vehicle height adjustment and input unit 153, the vehicle height adjustment and input unit 153 has a configuration in which target vehicle heights in three levels including high, medium, and low are displayed in a display portion, and thus the driver can select a target vehicle height, and a selected signal is transmitted to the second control unit 142. The second control unit 142 controls the hydraulic jack 100 such that the suspension spring 24 is adjusted in the expansion and contraction direction by a target movement amount corresponding to the target vehicle height.

The movement amount sensor 154 is a detection unit that detects a movement amount of the plunger 32 with respect to the jack housing 31, that is, an expansion and contraction amount of the jack portion 30 (an adjustment amount of the suspension spring 24).

The control device 140 includes the first control unit 141 that controls the first hydraulic drive device 60 and the motor 130, and the second control unit 142 that controls the second hydraulic drive device 100 and the motor 130. That is, the first control unit 141 and the second control unit 142 are integrated into the single control device 140. Therefore, the size of the entire control device 140 can be reduced as compared with a case where the first control unit 141 and the second control unit 142 are configured separately.

The first control unit 141 and the second control unit 142 are configured to simultaneously execute the respective controls. When the first control unit 141 controls the first hydraulic drive device 60 (the ABS 60), the second control unit 142 simultaneously controls the second hydraulic drive device 100 (the hydraulic jack 100), that is, performs a parallel control, and communicates mutually associated signals. Therefore, it is possible to more quickly operate the first hydraulic drive device 60 and the second hydraulic drive device 100.

Further, the control device 140 includes a first valve drive unit 143 that receives a control signal of the first control unit 141 and drives the first inlet control valve 62 and the first outlet control valve 63, a second valve drive unit 144 that receives a control signal of the second control unit 142 and drives the second inlet control valve 115 and the second outlet control valve 116, and a motor drive unit 145 that receives control signals of the first control unit 141 and the second control unit 142 and drives the motor 130.

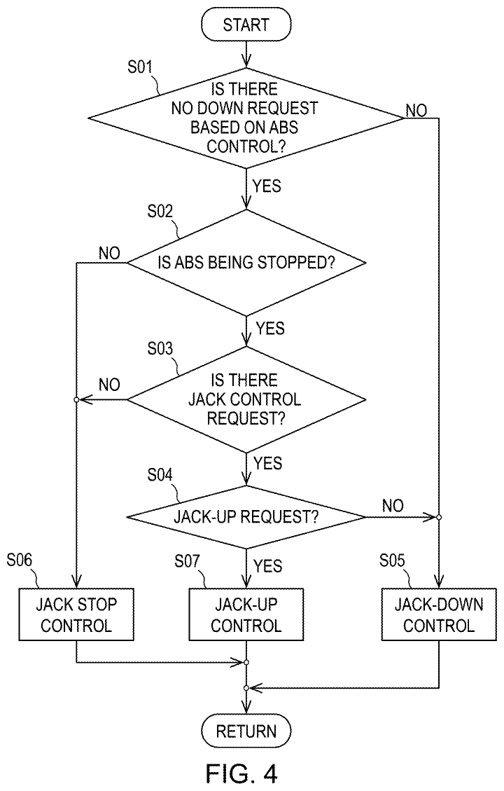

Next, the controls performed by the control device 140 will be described based on FIG. 4 with reference to FIG. 3. The control device 140 is implemented by, for example, a microcomputer. A specific control example of the control device 140 implemented by a microcomputer will be described as follows.

FIG. 4 is a control flowchart of the control device 140, and illustrates a subroutine for executing a process of controlling operations of the first hydraulic drive device 60, the second hydraulic drive device 100, and the motor 130 among the series of controls performed by the control device 140. This subroutine is executed by, for example, an interruption process based on a predetermined condition or a time division process.

When the control device 140 starts the control, first, in step S01, the control device 140 determines whether there is a request to descend the hydraulic jack 100 from the first control unit 141 (a jack-down request based on an ABS control). For example, when a brake control of the hydraulic brake 60 requires to reduce the vehicle height, the first control unit 141 issues the jack-down request based on the ABS control.

If it is determined in step S01 that there is no jack-down request, the process proceeds to the next step S02. If it is determined in step S01 that there is the jack-down request, the process proceeds to step S05, and ends the subroutine after a jack-down control for descending the hydraulic jack 100 is executed. Therefore, when there is the jack-down request, the hydraulic jack 100 starts to reduce the vehicle height. While the jack-down request is consecutive, the hydraulic jack 100 maintains a reduced state of the vehicle height.

For example, in a case where the first control unit 141 determines that a start condition for starting the brake control of the hydraulic brake 60 is satisfied when the second control unit 142 controls the operation of the hydraulic jack 100 (step S01), the second control unit 142 performs a control of descending the hydraulic jack 100 (step S05).

In step S02, it is determined whether the ABS 60 is being stopped. In step S02, the determination can be performed based on the presence or absence of an ABS stop signal from the first control unit 141. If it is determined in step S02 that the ABS 60 is stopped or the ABS 60 is being stopped, the process proceeds to the next step S03. If it is determined in step S02 that the ABS 60 is operating (is not being stopped), the process proceeds to step S06, and the subroutine ends after a jack stop control for stopping the hydraulic jack 100 is executed. Accordingly, when the ABS 60 starts the operation, the hydraulic jack 100 stops. Further, when the ABS 60 is operating, the hydraulic jack 100 maintains the stop state.

In step S03, it is determined whether there is a request for controlling the hydraulic jack 100 (a jack control command) from the vehicle height adjustment and input unit 153. If it is determined in step S03 that there is the request for the control, the process proceeds to the next step S04. If it is determined in step S03 that there is no request for controlling the hydraulic jack 100, the process proceeds to step S06, and the subroutine ends after the jack stop control for stopping the hydraulic jack 100 is executed. Accordingly, the hydraulic jack 100 maintains the stop state for the vehicle height until the jack control command is received from the vehicle height adjustment and input unit 153.

In step S04, it is determined whether the request from the vehicle height adjustment and input unit 153 is a request for raising the hydraulic jack 100 (a jack-up command). If it is determined in step S04 that the request is the request for raising the hydraulic jack 100, the process proceeds to the next step S07, and the subroutine ends after the jack-up control for raising the hydraulic jack 100 is executed. Accordingly, when there is a jack-up request, the hydraulic jack 100 starts to increase the vehicle height. While the jack-up request is consecutive, the hydraulic jack 100 maintains an increased state of the vehicle height.

On the other hand, if it is determined in step S04 that the request from the vehicle height adjustment and input unit 153 is the request for descending the hydraulic jack 100, the process proceeds to step SOS, and the subroutine ends after the jack-down control for descending the hydraulic jack 100 is executed. Therefore, when there is the jack-down request, the hydraulic jack 100 starts to reduce the vehicle height. While the jack-down request is consecutive, the hydraulic jack 100 maintains a reduced state of the vehicle height.

Next, an operation of the vehicular hydraulic system 40 will be described with reference to FIG. 3.

For example, when a main switch (not shown) of the motorcycle 10 is in an on state, the vehicular hydraulic system 40 operates, and thus the first control unit 141 and the second control unit 142 can also operate, and both the ABS and the vehicle height (both the ABS 60 and the hydraulic jack 100) can be controlled.

The ABS 60 and the hydraulic jack 100 are in the stop state (a normal state) illustrated in FIG. 3. Therefore, the first control unit 141 issues the ABS stop signal to the second control unit 142 (a stop mode). Similarly, the second control unit 142 issues a jack stop signal to the first control unit 141.

Generally, the first reservoir 61 temporarily stores the oil, and the oil does not flow therein in the stop state of the ABS 60. Therefore, the first hydraulic pump 80 merely rotates idly without sucking the oil from the first reservoir 61. The brake hydraulic pressure generated by the rotation of the first hydraulic pump 80 is not applied to the brake caliper 55. In the stop state of the ABS 60, the first inlet control valve 62 is in the opened state, and the first outlet control valve 63 is in the closed state. Unless the brake operation member 51 is operated, the brake hydraulic pressure is not applied from the master cylinder 52 to the brake caliper 55.

On the other hand, the oil for increasing the jack hydraulic pressure is stored in the second reservoir 111. However, in the hydraulic jack 100, both the second inlet control valve 115 and the second outlet control valve 116 are closed. The second hydraulic pump 120 merely rotates idly without sucking the oil from the second reservoir 111. The oil in the second reservoir 111 does not flow into the jack chamber 33. The oil in the jack chamber 33 does not flow into the second reservoir 111. Since the jack hydraulic pressure of the jack chamber 33 does not change, the vehicle height of the motorcycle 10 is maintained. For example, the vehicle height of the motorcycle 10 is at the low level. In this way, the second hydraulic circuit 90 maintains a jack stop state.

In a state where the first control unit 141 maintains the ABS stop signal, the driver operates the vehicle height adjustment and input unit 153 regardless of whether the motorcycle 10 is being stopped or is traveling, and thus the second control unit 142 performs the jack-up control (see steps S01 to S04 and S07 in FIG. 4). That is, the second control unit 142 opens only the second inlet control valve 115 in response to an operation signal of the vehicle height adjustment and input unit 153. The second hydraulic pump 120 becomes capable of sucking the oil from the second reservoir 111, and applies the jack hydraulic pressure to the jack portion 30. As a result, the hydraulic shock absorber 20 expands and increases the vehicle height of the motorcycle 10. The second control unit 142 issues a jack-up signal to the first control unit 141. The first control unit 141 maintains the ABS stop signal and does not affect the control on the hydraulic jack 100 performed by the second control unit 142.

Thereafter, when the movement amount sensor 154 detects that the vehicle height is increased to the setting value, the movement amount sensor 154 issues a detection signal to the second control unit 142. The second control unit 142 executes a jack maintaining control (see steps S01 to S03 and S06 in FIG. 4). That is, the second control unit 142 closes the second inlet control valve 115. As a result, the expansion operation of the hydraulic shock absorber 20 is stopped, and the vehicle height is maintained. The second control unit 142 issues a jack maintaining signal to the first control unit 141.

Thereafter, in the state where the first control unit 141 maintains the ABS stop signal, the driver operates the vehicle height adjustment and input unit 153 such that the vehicle height is reduced, and thus the second control unit 142 performs the jack-down control in response to a signal of the vehicle height adjustment and input unit 153 (see steps S01 to S05 in FIG. 4). That is, the second control unit 142 opens only the second outlet control valve 116. As a result, since the oil returns from the jack portion 30 to the second reservoir 111, the jack hydraulic pressure decreases. The hydraulic shock absorber 20 is retracted to reduce the vehicle height. The second control unit 142 issues a jack-down signal to the first control unit 141.

When the brake operation member 51 is operated while the motorcycle 10 is traveling, the brake hydraulic pressure generated in the master cylinder 52 is applied to the brake caliper 55 through the first brake hydraulic passage 71 and via the first inlet control valve 62. The front wheel 14 can be braked by only the brake hydraulic pressure generated in the master cylinder 52.

In this case, since the ABS 60 is being stopped, the first control unit 141 issues the ABS stop signal to the second control unit 142 (it is determined to be YES in both steps S01 to S02 in FIG. 4). Therefore, the control on the hydraulic jack 100 performed by the second control unit 142 is not affected.

During braking of the front wheel 14, when the first control unit 141 determines that it is necessary to avoid the slipping (the locked state) of the front wheel 14, the first control unit 141 issues a pressure reduction control signal so as to reduce the brake hydraulic pressure (an ABS pressure reduction mode). The first inlet control valve 62 receives the pressure reduction control signal and switches to the closed state. The first outlet control valve 63 receives the pressure reduction control signal and switches to the opened state. As a result, the brake hydraulic pressure in the brake caliper 55 is released to the first reservoir 61. Accordingly, the brake hydraulic pressure in the brake caliper 55 is reduced, and thus the slipping (the locked state) of the front wheel 14 can be avoided. Since the first inlet control valve 62 is closed, the brake hydraulic pressure generated by the rotation of the first hydraulic pump 80 is not applied to the brake caliper 55.

Further, when the first control unit 141 determines that it is necessary to increase the current brake hydraulic pressure applied to the brake caliper 55 during the braking of the front wheel 14, the first control unit 141 generates a pressure increase control signal to increase the brake hydraulic pressure (an ABS pressure increase mode). The first inlet control valve 62 receives the pressure increase control signal and opens. The first outlet control valve 63 receives the pressure increase control signal and closes. As a result, the brake hydraulic pressure in the brake caliper 55 is increased.

Further, when the first control unit 141 determines that it is necessary to hold the current brake hydraulic pressure applied to the brake caliper 55 during the braking of the front wheel 14, the first control unit 141 generates a holding control signal to hold the brake hydraulic pressure (an ABS hold mode).

For example, the first control unit 141 generates the holding control signal described above in the following case. That is, a case where in a current braking state, it is determined that the brake hydraulic pressure applied from the master cylinder 52 to the brake caliper 55 is excessive.

In the ABS hold mode, both the first inlet control valve 62 and the first outlet control valve 63 receive the holding control signal and close. The brake hydraulic pressure generated in the master cylinder 52 is not applied to the brake caliper 55. The first hydraulic pump 80 merely rotates idly. The brake hydraulic pressure generated by the rotation of the first hydraulic pump 80 is not applied to the brake caliper 55. As a result, the brake hydraulic pressure in the brake caliper 55 is held.

As described above, when the ABS 60 is in any one of the ABS pressure reduction mode, the ABS pressure increase mode, and the ABS hold mode, the first control unit 141 issues an ABS operation signal to the second control unit 142 (it is determined to be NO in step S02 in FIG. 4). Therefore, the second control unit 142 stops the hydraulic jack 100 (see step S06 in FIG. 4) by switching the second inlet control valve 115 and the second outlet control valve 116 to the closed state illustrated in FIG. 3. As a result, the hydraulic shock absorber 20 stops at a current advancing or retracting position, and maintains the vehicle height of the motorcycle 10 in this situation.

On the other hand, when the first control unit 141 issues a jack-down request signal based on the ABS control to the second control unit 142 (it is determined to be NO in step S01 in FIG. 4), the second control unit 142 closes the second inlet control valve 115 and opens the second outlet control valve 116. As a result, the hydraulic jack 100 reduces the vehicle height of the motorcycle 10. The “jack-down request based on the ABS control” is not limited as long as the first control unit 141 reduces the vehicle height of the motorcycle 10, for example, may be a case where the ABS 60 is in any one of the ABS pressure reduction mode, the ABS pressure increase mode, and the ABS hold mode.

A criterion for the first control unit 141 determining that the ABS 60 is in any one of the pressure reduction mode, the ABS pressure increase mode, and the ABS hold mode is, for example, a threshold value of a deceleration change rate of the rotational speed of the front wheel 14 detected by the wheel speed sensor 152.

A relation between the first control unit 141 and the second control unit 142 is summarized as follows.

When the first control unit 141 controls the operation of the hydraulic brake 60 (step S02), the second control unit 142 controls the hydraulic jack 100 to be in the stop state (step S06). During the operation of the hydraulic brake 60 (the ABS 60), the hydraulic jack 100 is stopped, and thus the traveling stability of the motorcycle 10 can be further improved.

Further, in the case where the first control unit 141 determines that the start condition for starting the brake control of the hydraulic brake 60 is satisfied when the second control unit 142 controls the operation of the hydraulic jack 100 (step SOI or step S02), the second control unit 142 is configured to control to stop the operation of the hydraulic jack 100 (step S06), or cause the hydraulic jack 100 to descend (step S05).

Therefore, when the brake control of the hydraulic brake 60 is started, the operation of the hydraulic jack 100 can be stopped. The traveling stability of the motorcycle 10 can be further improved.

Alternatively, when it is determined that the brake control of the hydraulic brake 60 requires the reduction of the vehicle height, the hydraulic jack 100 can be descended. Since the vehicle height of the motorcycle 10 is reduced, the gravity center of the motorcycle 10 is lowered. The traveling stability of the motorcycle 10 can be further improved. In addition, a lifting phenomenon of a rear portion of the motorcycle 10 can be restrained. During the brake control, it is possible to shorten a distance (a braking distance) by which the motorcycle 10 travels while braking.

The above description of Example 1 is summarized as follows.

As illustrated in FIG. 3, the vehicular hydraulic system 40 includes the first hydraulic drive device 60 that is driven by the hydraulic pressure generated in the first hydraulic pump 80, the second hydraulic drive device 100 that exhibits an action different from that of the first hydraulic drive device 60 and is driven by the hydraulic pressure generated in the second hydraulic pump 120, and the single motor 130 serving as the common power source for the first hydraulic pump 80 and the second hydraulic pump 120.

In the vehicular hydraulic system 40 including the two hydraulic drive devices 60, 100 exhibiting different actions in this manner, the single motor 130 may serve as a common power source by rotating the single motor 130. Therefore, it is possible to provide the vehicular hydraulic system 40 that can reduce an arrangement space and mounting weight with respect to the motorcycle 10 (the vehicle 10).

Further, the first hydraulic drive device 60 is implemented by a hydraulic brake which is allowed to be provided in the motorcycle 10 (the vehicle 10). The second hydraulic drive device 100 is implemented by a hydraulic jack for adjusting the vehicle height of the motorcycle 10.

The hydraulic brake 60 (the ABS 60) is used in a special situation where the hydraulic pressure applied to the wheel brake 53 is controlled when the motorcycle 10 is urgently decelerated by being braked. On the other hand, the hydraulic jack 100 is used when handling characteristics and riding comfort characteristics are adjusted during the traveling of the motorcycle 10. That is, while the hydraulic brake 60 has an operation mode for emergency braking, the hydraulic jack 100 has an operation mode for normal traveling. The hydraulic brake 60 and the hydraulic jack 100 have completely different operation modes (exhibit different actions).

The first hydraulic pump 80 may operate only when the hydraulic pressure applied to the wheel brake 53 is controlled. The second hydraulic pump 120 may operate only when the hydraulic jack 100 is adjusted. Therefore, the hydraulic pumps 80, 120 may operate at different timings. Timings of the loads acting on the hydraulic pumps 80 and 120 also differ from each other. As a result, the load of the single motor 130 that drives both the hydraulic pumps 80, 120 is significantly smaller than that in a case of driving the hydraulic pumps 80, 120 at the same timing. The size of the motor 130 can be reduced. The weight of the vehicular hydraulic system 40 mounted on the motorcycle 10 can be reduced.

In addition, even when both the hydraulic pumps 80, 120 are driven simultaneously and continuously by the single motor 130, the functions of the hydraulic brake 60 and the hydraulic jack 100 exhibiting completely different actions are not affected. By reducing the number of the motors 130 driving both the hydraulic pumps 80, 120, the size of the vehicular hydraulic system 40 can be reduced. The vehicular hydraulic system 40 can be easily arranged in a narrow arrangement space of the motorcycle 10.

Further, the hydraulic pressure control unit 110 includes the reservoir 111 (the second reservoir 111) in which the oil is stored, the first jack hydraulic passage 112 through which the oil is supplied from the reservoir 111 to the jack portion 30, the second jack hydraulic passage 113 through which the oil is returned from the jack portion 30 to the reservoir 111, the inlet control valve 115 (the second inlet control valve 115) provided in the first jack hydraulic passage 112 together with the second hydraulic pump 120, and the outlet control valve 116 (the second outlet control valve 116) provided in the second jack hydraulic passage 113.

Therefore, even when the second hydraulic pump 120 continuously supplies the oil from the reservoir 111 to the jack portion 30, the supply and the return of the oil can be easily switched by using the inlet control valve 115 and the outlet control valve 116 to switch the first jack hydraulic passage 112 and the second jack hydraulic passage 113.

Further, the vehicular hydraulic system 40 includes the pressure valve 117 that releases the excessive hydraulic pressure applied to at least one of the discharge side of the first hydraulic pump 80 and the discharge side of the second hydraulic pump 120 (for example, the discharge side of the second hydraulic pump 120). Therefore, at least one of the first hydraulic pump 80 and the second hydraulic pump 120 can be protected from the excessive hydraulic pressure by the pressure valve 117.

### Example 2

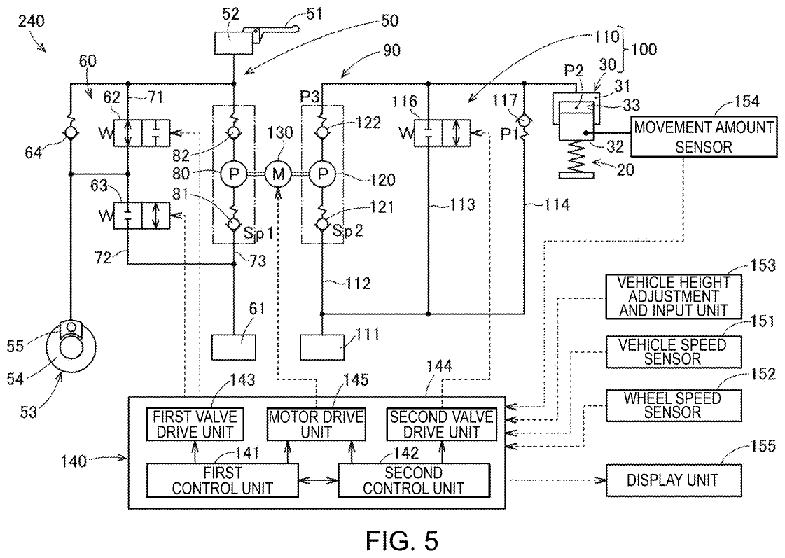

Next, a vehicular hydraulic system 240 according to Example 2 will be described with reference to FIG. 5.

FIG. 5 is a diagram illustrating a hydraulic circuit of the vehicular hydraulic system 240 according to Example 2, and illustrates the hydraulic circuit in a manner of corresponding to FIG. 3 illustrating the vehicular hydraulic system 40 according to Example 1.

The vehicular hydraulic system 240 according to Example 2 has a feature that the second inlet control valve 115 according to Example 1 is eliminated from the first jack hydraulic passage 112 of the hydraulic pressure control unit 110. Other basic components are common to the vehicular hydraulic system 40 according to Example 1. The components common to the vehicular hydraulic system 40 according to Example 1 are denoted by the same reference numerals, and detailed descriptions thereof are omitted.

In Example 2, the hydraulic pressure control unit 110 includes the reservoir 111 (the second reservoir 111) in which the oil is stored, the first jack hydraulic passage 112 through which the oil is supplied from the reservoir 111 to the jack portion 30, the second jack hydraulic passage 113 through which the oil is returned from the jack portion 30 to the reservoir 111, and the outlet control valve 116 (the second outlet control valve 116) provided in the second jack hydraulic passage 113. Only the second hydraulic pump 120 is provided in the first jack hydraulic passage 112 without providing a control valve.

As described above, no control valve is provided in the first jack hydraulic passage 112. The second hydraulic pump 120 supplies the oil from the reservoir 111 to the jack portion 30 by a motor control based on the ABS control, and thus the excessive oil can be supplied to the jack portion 30. However, when the outlet control valve 116 intermittently opens and closes the second jack hydraulic passage 113, the excessively supplied oil can be returned to the reservoir 111. Further, when the outlet control valve 116 opens the second jack hydraulic passage 113, the oil can be returned to the reservoir 111. Therefore, the supply and the return of the oil with respect to the jack portion 30 can be easily switched by only the outlet control valve 116. Since no control valve is provided in the first jack hydraulic passage 112, cost reduction of the vehicular hydraulic system 240 can be achieved.

Other operations and effects are the same as the operations and effects obtained by the vehicular hydraulic system 40 according to Example 1.

The vehicular hydraulic systems 40, 240 according to the present disclosure are not limited to the Examples described above as long as the operations and effects of the present disclosure can be obtained.

For example, the first inlet control valve 62, the first outlet control valve 63, the second inlet control valve 115, and the second outlet control valve 116 are not limited to the configuration of the electromagnetic valve that simply opens and closes. For example, each of the first inlet control valve 62, the first outlet control valve 63, the second inlet control valve 115, and the second outlet control valve 116 may be a valve whose opening degree changes in response to the control signal of the control device 140.

In addition, the first hydraulic pump 80 and the second hydraulic pump 120 are not limited to the configuration of the plunger pump, and may have a configuration of a trochoid pump, for example.

Further, the first hydraulic pump 80, the second hydraulic pump 120, and the motor 130 may be configured as an integrated unit.

The pressure valve 117 may include at least one of a valve that is provided in the first hydraulic circuit 50 and protects the first hydraulic pump 80 and a valve that is provided in the second hydraulic circuit 90 and protects the second hydraulic pump 120.

If it is determined in step S01 in FIG. 4 that there is the request to descend the hydraulic jack 100 from the first control unit 141, the process may proceed to step S06 instead of step S05, and the jack stop control for stopping the hydraulic jack 100 may be executed.

Further, if it is determined in step S02 in FIG. 4 that the ABS 60 operates, the process may proceed to step S05 instead of step S06, and the jack-down control for descending the hydraulic jack 100 may be executed.

In addition, the vehicular hydraulic systems 40, 240 freely have a configuration in which when the first control unit 141 controls the operation of the hydraulic brake 60, the second control unit 142 simultaneously controls the operation of the hydraulic jack 100 as it is without stopping or descending the hydraulic jack 100.

Further, the vehicular hydraulic systems 40, 240 can be configured by using a vehicular hydraulic system provided with a two-channel hydraulic brake including a front wheel hydraulic brake and a rear wheel hydraulic brake of the motorcycle.

The vehicular hydraulic systems 40, 240 according to the present disclosure are suitable for being mounted on a saddle-riding type vehicle.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A vehicular hydraulic system, comprising:
a first hydraulic drive device configured to be driven by a hydraulic pressure generated in a first hydraulic pump;
a second hydraulic drive device configured to exhibit an action different from that of the first hydraulic drive device, and to be driven by a hydraulic pressure generated in a second hydraulic pump; and
a single motor serving as a common power source for the first hydraulic pump and the second hydraulic pump,
wherein a first hydraulic circuit including the first hydraulic pump and the first hydraulic drive device and a second hydraulic circuit including the second hydraulic pump and the second hydraulic drive device are separated and independent from each other,
the first hydraulic drive device is implemented by a hydraulic brake which is allowed to be provided in a vehicle,
the second hydraulic drive device is implemented by a hydraulic jack for adjusting a vehicle height of the vehicle,
the hydraulic jack includes:
a jack portion; and
a hydraulic pressure control unit configured to control a hydraulic pressure of the jack portion, and
the hydraulic pressure control unit includes:
a reservoir in which oil is stored;
a first jack hydraulic passage through which the oil is supplied from the reservoir to the jack portion;
a second jack hydraulic passage through which the oil is returned from the jack portion to the reservoir;
an inlet control valve provided in the first jack hydraulic passage together with the second hydraulic pump; and
an outlet control valve provided in the second jack hydraulic passage.

2. The vehicular hydraulic system according to claim 1, further comprising:
a pressure valve configured to release an excessive hydraulic pressure applied to at least one of a discharge side of the first hydraulic pump and a discharge side of the second hydraulic pump.

3. A vehicular hydraulic system, comprising:
a first hydraulic drive device configured to be driven by a hydraulic pressure generated in a first hydraulic pump;
a second hydraulic drive device configured to exhibit an action different from that of the first hydraulic drive device, and to be driven by a hydraulic pressure generated in a second hydraulic pump; and
a single motor serving as a common power source for the first hydraulic pump and the second hydraulic pump,
wherein a first hydraulic circuit including the first hydraulic pump and the first hydraulic drive device and a second hydraulic circuit including the second hydraulic pump and the second hydraulic drive device are separated and independent from each other,
the first hydraulic drive device is implemented by a hydraulic brake which is allowed to be provided in a vehicle,
the second hydraulic drive device is implemented by a hydraulic jack for adjusting a vehicle height of the vehicle,
the hydraulic brake includes a first reservoir, in which oil is stored, connected to a brake caliper,
a first intake valve that allows only an inflow of the oil from the first reservoir to the first hydraulic pump is interposed in an oil passage through which the oil is sucked from the first reservoir by the first hydraulic pump,
the hydraulic jack includes a second reservoir in which oil is stored,
a second intake valve that allows only an inflow of the oil from the second reservoir to the second hydraulic pump is interposed in an oil passage through which the oil flows from the second reservoir to a sucking port of the second hydraulic pump, and
a reference negative pressure with which the first intake valve is opened due to sucking of the first hydraulic pump is set to be larger than a reference negative pressure with which the second intake valve is opened due to sucking of the second hydraulic pump.

4. The vehicular hydraulic system according to claim 1,
wherein the second hydraulic circuit including the hydraulic jack includes a pressure valve for protecting the second hydraulic pump, and
a valve opening pressure of the pressure valve is set to be larger than a maximum jack pressure for driving the hydraulic jack and smaller than a maximum discharge pressure of the second hydraulic pump.

5. The vehicular hydraulic system according to claim 1, further comprising:
a first control unit configured to control the first hydraulic drive device; and
a second control unit configured to control the second hydraulic drive device,
wherein the first control unit and the second control unit are integrated into a single control device.

6. The vehicular hydraulic system according to claim 1, further comprising:
a first control unit configured to control the hydraulic brake; and
a second control unit configured to control the hydraulic jack,
wherein the first control unit and the second control unit are configured to simultaneously execute the respective controls.

7. The vehicular hydraulic system according to claim 6,
wherein when the first control unit controls an operation of the hydraulic brake, the second control unit is configured to control the hydraulic jack to be in a stop state.

8. The vehicular hydraulic system according to claim 6,
wherein in a case where the first control unit determines that a start condition for starting a brake control of the hydraulic brake is satisfied when the second control unit controls an operation of the hydraulic jack, the second control unit is configured to control to stop the operation of the hydraulic jack or cause the hydraulic jack to descend.

9. The vehicular hydraulic system according to claim 7,
wherein in a case where the first control unit determines that a start condition for starting a brake control of the hydraulic brake is satisfied when the second control unit controls an operation of the hydraulic jack, the second control unit is configured to control to stop the operation of the hydraulic jack or cause the hydraulic jack to descend.

10. The vehicular hydraulic system according to claim 2,
wherein the second hydraulic circuit including the hydraulic jack includes a pressure valve for protecting the second hydraulic pump, and
a valve opening pressure of the pressure valve is set to be larger than a maximum jack pressure for driving the hydraulic jack and smaller than a maximum discharge pressure of the second hydraulic pump.

11. The vehicular hydraulic system according to claim 2, further comprising:
a first control unit configured to control the first hydraulic drive device; and
a second control unit configured to control the second hydraulic drive device,
wherein the first control unit and the second control unit are integrated into a single control device.

12. The vehicular hydraulic system according to claim 2, further comprising:
a first control unit configured to control the hydraulic brake; and
a second control unit configured to control the hydraulic jack,
wherein the first control unit and the second control unit are configured to simultaneously execute the respective controls.

13. The vehicular hydraulic system according to claim 12,
wherein when the first control unit controls an operation of the hydraulic brake, the second control unit is configured to control the hydraulic jack to be in a stop state.

14. The vehicular hydraulic system according to claim 12,
wherein in a case where the first control unit determines that a start condition for starting a brake control of the hydraulic brake is satisfied when the second control unit controls an operation of the hydraulic jack, the second control unit is configured to control to stop the operation of the hydraulic jack or cause the hydraulic jack to descend.

15. The vehicular hydraulic system according to claim 13,
wherein in a case where the first control unit determines that a start condition for starting a brake control of the hydraulic brake is satisfied when the second control unit controls an operation of the hydraulic jack, the second control unit is configured to control to stop the operation of the hydraulic jack or cause the hydraulic jack to descend.

16. The vehicular hydraulic system according to claim 3,
wherein the second hydraulic circuit including the hydraulic jack includes a pressure valve for protecting the second hydraulic pump, and
a valve opening pressure of the pressure valve is set to be larger than a maximum jack pressure for driving the hydraulic jack and smaller than a maximum discharge pressure of the second hydraulic pump.

17. The vehicular hydraulic system according to claim 3, further comprising:
a first control unit configured to control the first hydraulic drive device; and
a second control unit configured to control the second hydraulic drive device,
wherein the first control unit and the second control unit are integrated into a single control device.

18. The vehicular hydraulic system according to claim 3, further comprising:
a first control unit configured to control the hydraulic brake; and
a second control unit configured to control the hydraulic jack,
wherein the first control unit and the second control unit are configured to simultaneously execute the respective controls.

19. The vehicular hydraulic system according to claim 18,
wherein when the first control unit controls an operation of the hydraulic brake, the second control unit is configured to control the hydraulic jack to be in a stop state.

20. The vehicular hydraulic system according to claim 18,
wherein in a case where the first control unit determines that a start condition for starting a brake control of the hydraulic brake is satisfied when the second control unit controls an operation of the hydraulic jack, the second control unit is configured to control to stop the operation of the hydraulic jack or cause the hydraulic jack to descend.
